(19) United States
(12) Patent Application Publication
(10) Pub. No.: US 2005/0276493 A1
(43) Pub. Date: Dec. 15, 2005

(54) Selecting macroblock coding modes for video encoding

(76) Inventors: Jun Xin, Quincy, MA (US); Anthony Vetro, Cambridge, MA (US); Huifang Sun, Billerica, MA (US)

Correspondence Address: MITSUBISHI ELECTRIC INFORMATION;TECHNOLOGY CENTER AMERICA, 8TH FLOOR, 201 BROADWAY, CAMBRIDGE, MA, 02139, US

(21) Appl. No.: 10/858,162

(22) Filed: Jun. 1, 2004

(51) Int. Cl. G06K 9/36; G06K 9/46

(52) U.S. Cl. 382/239; 382/236

(57) ABSTRACT

A method selects an optimal coding mode for each macroblock in a video. Each macroblock can be coded according a number of candidate coding modes. A difference between an input macroblock and a predicted macroblock is determined in a transform-domain. The difference is quantized to yield a quantized difference. An inverse quantization is performed on the quantized difference to yield a reconstructed difference. A rate required to code the quantized difference is determined. A distortion is determined according to the difference and the reconstructed difference. Then, a cost is determined for each candidate mode based on the rate and the distortion, and the candidate coding mode that yields a minimum cost is selected as the optimal coding mode for the macroblock.

### RELATED APPLICATION

This application is related to U.S. patent application Ser. No. ______, “Transcoding Videos Based on Different Transformation Kernels” co-filed herewith by Xin et al., on Jun. 1, 2004, and incorporated herein by reference.

### FIELD OF THE INVENTION

The invention relates generally to video coding and more particularly to selecting macroblock coding modes for video encoding.

### BACKGROUND OF THE INVENTION

International video coding standards, including MPEG-1, MPEG-2, MPEG-4, H.261, H.263 and H.264/AVC, are all based on a basic hybrid coding framework that uses motion compensated prediction to remove temporal correlations and transforms to remove spatial correlations.

MPEG-2 is a video coding standard developed by the Motion Picture Expert Group (MPEG) of ISO/IEC. It is currently the most widely used video coding standard. Its applications include digital television broadcasting, direct satellite broadcasting, DVD, video surveillance, etc. The transform used in MPEG-2, as well as a variety of other video coding standards, is a discrete cosine transform (DCT). Therefore, an MPEG encoded video uses DCT coefficients.

Advanced video coding according to the H.264/AVC standard is intended to significantly improve compression efficiency over earlier standards, including MPEG-2. This standard is expected to have a broad range of applications, including efficient video storage, video conferencing, and video broadcasting over DSL. The AVC standard uses a low-complexity integer transform, hereinafter referred to as HT. Therefore, an encoded AVC video uses HT coefficients.

The basic encoding process of such a standard prior art video encoder 100 is shown in FIG. 1. Each frame of an input video 101 is divided into macroblocks. Each macroblock is subjected to a transform/quantization 104 and entropy coding 115. The output of the transform/quantization 104 is subjected to an inverse quantization/transform 105. Motion estimation 109 is performed, and a coding mode decision 110 is made considering the content of a pixel buffer 107. The coding mode decision produces an optimal coding mode 120. Then, the result of the prediction 108 is subtracted 103 from the input signal to produce an error signal. The result of the prediction is also added 106 to the output of the inverse quantization/transform and stored into the pixel buffer.

The output 102 can be a macroblock encoded as an intra-macroblock, which uses information from just the current frame. Alternatively, the output 102 can be a macroblock encoded as an inter-macroblock, which is predicted using motion vectors that are estimated through motion estimation from the current and previous frames. There are various ways to perform intra-prediction or inter-prediction.

In general, each frame of video is divided into macroblocks, where each macroblock consists of a plurality of smaller-sized blocks. The macroblock is the basic unit of encoding, while the blocks typically correspond to the dimension of the transform. For instance, both MPEG-2 and H.264/AVC specify 16×16 macroblocks. However, the block size in MPEG-2 is 8×8, corresponding to 8×8 DCT and inverse DCT operations, while the block size in H.264/AVC is 4×4 corresponding to the 4×4 HT and inverse HT operations.

The notion of a macroblock partition is often used to refer to the group of pixels in a macroblock that share a common prediction. The dimensions of a macroblock, block and macroblock partition are not necessarily equal. An allowable set of macroblock partitions typically vary from one coding scheme to another.

For instance, in MPEG-2, a 16×16 macroblock may have two 8×16 macroblock partitions; each macroblock partition undergoes a separate motion compensated prediction. However, the motion compensated differences resulting in each partition may be coded as 8×8 blocks. On the other hand, AVC defines a much wider variety of allowable set of macroblock partitions. For instance, a 1 6×16 macroblock may have a mix of 8×8, 4×4, 4×8 and 8×4 macroblock partitions within a single macroblock. Prediction can then be performed independently for each macroblock partition, but the coding is still based on a 4×4 block

The encoder selects the coding modes for the macroblock, including the best macroblock partition and mode of prediction for each macroblock partition, such that the video coding performance is optimized. The selection process is conventionally referred to as ‘macroblock mode decision’.

In the recently developed H.264/AVC video coding standard there are many available modes for coding a macroblock. The available coding modes for a macroblock in an I-slice include:
intra_{—}4×4 prediction and intra_{—}16×16 prediction for luma samples; and
intra_{—}8×8 prediction for chroma samples.

In the intra_{—}4×4 prediction, each 4×4 macroblock partition can be coded using one of the nine prediction modes defined by the H.264/AVC standard. In the intra_{—}16×16 and intra_{—}8×8 predictions, each 16×16 or 8×8 macroblock partition can be coded using one of the four defined prediction modes. For a macroblock in a P-slice or B-slice, in addition to the coding modes available for I-slices, many more coding modes are available using various combinations of macroblock partitions and reference frames. Every macroblock coding mode provides a different rate-distortion (RD) trade-off.

It is an object of the invention to select the macroblock coding mode that optimizes the performance with respect to both rate (R) and distortion (D).

Typically, the rate-distortion optimization uses a Lagrange multiplier to make the macroblock mode decision. The rate-distortion optimization evaluates the Lagrange cost for each candidate coding mode for a macroblock and selects the mode with a minimum Lagrange cost.

If there are N candidate modes for coding a macroblock, then the Lagrange cost of the n^{th} candidate mode Jₙ, is the sum of the Lagrange cost of the macroblock partitions:

$$\begin{matrix}{J}_{n} = {\sum }_{i = 1}^{{P}_{n}} {J}_{n , i} & & n = 1 , 2 , … , N\end{matrix} \qquad ( 1 )$$

where Pₙ is the number of macroblock partitions of the n^{th} candidate mode. A macroblock partition can be of different size depending on the prediction mode. For example, the partition size is 4×4 for the intra_{—}4×4 prediction, and 16×16 for the intra_{—}16×16 prediction.

If the number of candidate coding modes for the i^{th} partition of the n^{th} macroblock is K_{n,i}, then the cost of this macroblock partition is

$$\begin{matrix}{J}_{n , i} = {min}_{k = 1 , 2 , … , {K}_{n , i}} ( {J}_{n , i , k} ) \\ = {min}_{k = 1 , 2 , … , {K}_{n , i}} ( {D}_{n , i , k} + λ \times {R}_{n , i , k} )\end{matrix} \qquad ( 2 )$$

where R and D are respectively the rate and distortion, and λ is the Lagrange multiplier. The Lagrange multiplier controls the rate-distortion tradeoff of the macroblock coding and may be derived from a quantization parameter. The above equation states that the Lagrange cost of the i^{th} partition of the n^{th} macroblock, J_{n,i}, is selected to be the minimum of the K_{n,i} costs that are yielded by the candidate coding modes for this partition. Therefore, the optimal coding mode of this partition is the one that yields J_{n,i}.

The optimal coding mode for the macroblock is selected to be the candidate mode that yields the minimum cost, i.e.,

$${J}^{*} = {min}_{n = 1 , 2 , … , N} {J}_{n} \qquad ( 3 )$$

FIG. 2 shows the conventional process of computing the Lagrange cost for a coding mode of a macroblock partition, i.e., J_{n,i,k}. A difference 202 between the input macroblock partition 101 and its prediction 201 is determined 221 and HT-transformed 222, i.e., the HT-transform is the 4×4 transform according to the H.264/AVC standard, quantized 223, and the rate 208 is computed 227. The quantized HT-coefficients 204 are also subject to inverse quantization (IQ) 224, inverse HT-transform 225, and prediction compensation 220 to reconstruct 226 the macroblock partition. The distortion 228 is then computed between the reconstructed 207 and the input 101 macroblock partitions. In the end, the minimum Lagrange cost 230 is computed 229 using the rate 208 and distortion 209. The optimal coding mode 120 then corresponds to the mode with the minimum cost.

This process for determining the Lagrange cost needs be performed many times because there are a large number of available modes for coding a macroblock according to the H.264/AVC standard. Therefore, the computation of the rate-distortion optimized coding mode decision is very intensive.

Consequently, there exists a need to perform efficient rate-distortion optimized macroblock mode decision in H.264/AVC video coding.

### SUMMARY OF THE INVENTION

A method selects an optimal coding mode for each macroblock in a video. Each macroblock can be coded according to a number of candidate coding modes.

A difference between an input macroblock and a predicted macroblock is determined in a transform-domain. The difference is quantized to yield a quantized difference. An inverse quantization is performed on the quantized difference to yield a reconstructed difference.

A rate required to code the quantized difference is determined. A distortion is determined according to the difference and the reconstructed difference. Then, a cost is determined for each candidate mode based on the rate and the distortion, and the candidate coding mode that yields a minimum cost is selected as the optimal coding mode for the macroblock.

### BRIEF DESCRIPTION OF THE DRAWINGS

FIG. 1 is a block diagram of the prior art encoding process of a standard video coder;

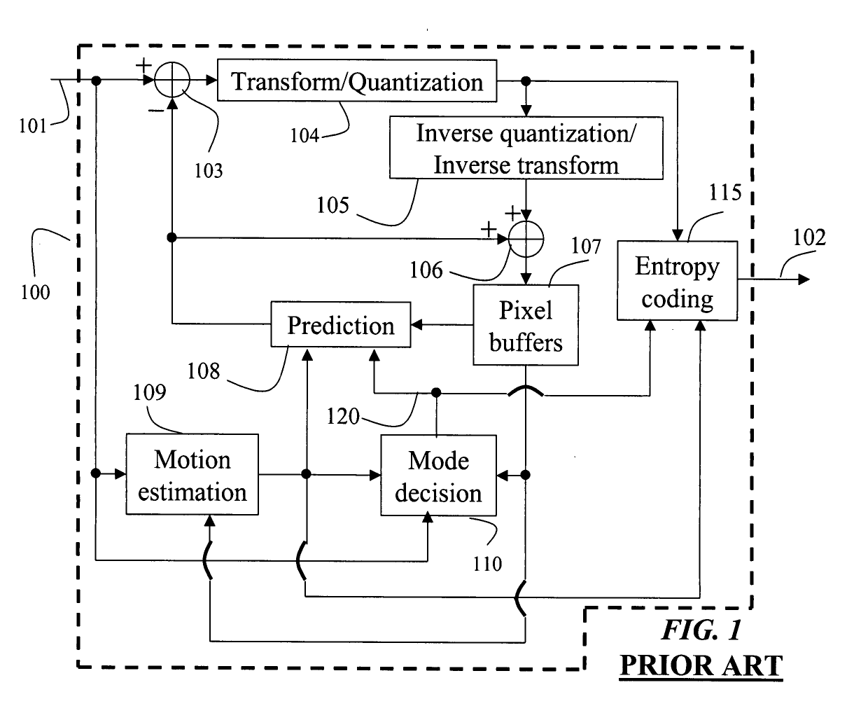

FIG. 2 is a block diagram of a prior art method for determining a Lagrange cost of a macroblock partition and the rate-distortion optimized mode decision for the H.264/AVC standard; and

FIG. 3 is the block diagram of a method for computing the Lagrange cost of a macroblock partition and the rate-distortion optimized mode decision according to the invention for the H.264/AVC standard.

### DETAILED DESCRIPTION OF THE PREFERRED EMBODIMENT

Our invention provides a method for determining a Lagrange cost, which leads to an efficient, rate-distortion optimized macroblock mode decision.

Method and System Overview

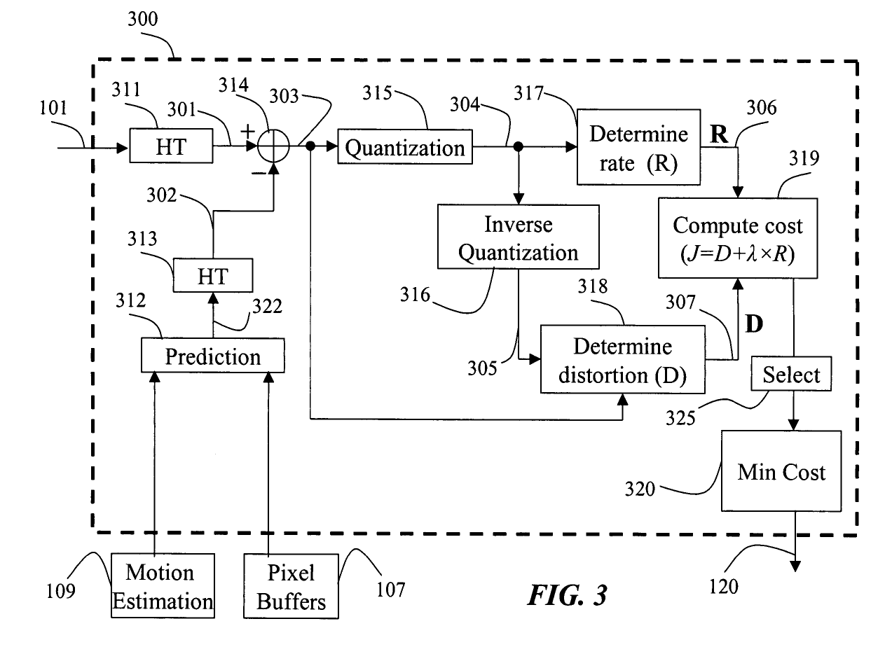

FIG. 3 shows the method and system 300, according to the invention, for selecting an optimal coding mode from multiple available candidate coding modes for each macroblock in a video. The selection is based on a Lagrange cost for a coding mode of a macroblock partition.

Both an input macroblock partition 101 and a predicted 312 macroblock partition prediction 322 are subject to HT-transforms 311 and 313, respectively. Each transform produces respective input 301 and predicted 302 HT-coefficients. Then, a difference 303 between the input HT-coefficient 301 and predicted HT-coefficient 302 is determined 314. The difference 303 is quantized 315 to produce a quantized difference 304 from which a coding rate R 306 is determined 317.

The quantized difference HT-coefficients are also subject to inverse quantization 316 to reconstruct the difference HT-coefficients 305. The distortion 307 is then determined 318 using the reconstructed HT-coefficients and the input difference HT-coefficients 303.

After the Lagrange cost is determined 319 from the rate and distortion, the optimal coding mode 120 for a macroblock partition is selected 325 from the available candidate coding modes to be the one yielding the minimum Lagrange cost 320.

The optimal combination of macroblock partitions and corresponding modes for a macroblock are determined by examining the individual Lagrange costs for the set of macroblock partitions. The combination yielding the minimum overall cost is selected as the optimal coding mode for a macroblock.

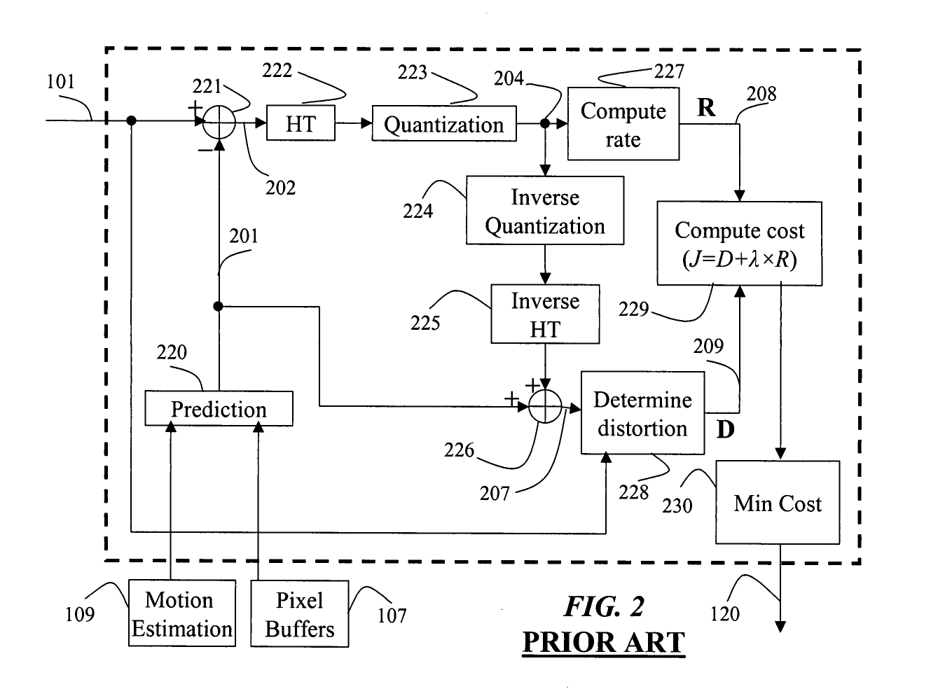

Compared to the prior art method, shown in FIG. 2, our invention has the following distinctive features:

We eliminate the inverse HT of the prior art method, which is computationally intensive. In this way, the reconstruction of the macroblock partition is also omitted by the invention.

The HT applies 311 and 313 to both the input and the predicted partition, instead of the difference of the input and the predicted partitions, as in the prior art.

The HT of the input macroblock partition 311 only needs to be performed once in the whole mode decision process, and the HT of the predicted partition 313 needs to be performed for every prediction mode. Hence, our invention needs to compute one more HT.

However, as we describe below, the HT of the predicted signal may be much more efficiently computed for some intra-prediction modes and the resulting savings may more than offset the additional HT.

The distortion is computed in the transform-domain instead of the pixel-domain as in the prior art, i.e., the distortion is computed directly using HT-coefficients. In the following, we provide a method to compute the distortion in the transform-domain such that it is approximately equal to the commonly used sum-of-squared-differences (SSD) distortion measure in the pixel-domain.

We have highlighted the use of the above method for efficiently computing the mode decision of the output within the context of an encoding system. However, this method could also be applied to transcoding videos, including the case when the input and output video formats are based on different transformation kernels.

In particular, when the above method is used in transcoding of intra-frames from MPEG-2 to H.264/AVC, the HT-coefficients of the input macroblock partition can be directly computed from the transform-coefficients of MPEG-2 video in the transform-domain, see related U.S. patent application Ser. No. ______, co-filed herewith by Xin et al., on Jun. 1, 2004, and incorporated herein by reference.

Therefore, in this case, the HT of the input macroblock partition is also omitted.

Determining Intra-Predicted HT-Coefficients

The prior art method for determining HT coefficients performs eight 1-D HT-transforms, i.e., four column-transforms followed by four row-transforms. However, some intra-predicted signals have certain properties that can make the computation of their HT coefficients much more efficient.

We describe efficient methods for determining HT coefficients for the following intra-prediction modes: DC prediction, horizontal prediction, and vertical prediction. These prediction modes are used in the intra_{—}4×4 and intra_{—}16×16 predictions for luma samples, as well as the intra_{—}8×8 prediction for chroma samples.

The following notations are used to describe the details of the present invention.
p—the predicted signal, 4×4 matrix
P—HT-coefficients of the predicted signal, p, 4×4 matrix
r, c—row and column index, r,c=1, 2, 3, 4
×—multiplication
(●)^{T}—matrix transpose
(●)⁻¹—matrix inverse
H—H.264/AVC transform (HT) kernel matrix, and

$$H = [ \begin{matrix}1 & 1 & 1 & 1 \\ 2 & 1 & - 1 & - 2 \\ 1 & - 1 & - 1 & 1 \\ 1 & - 2 & 2 & - 1\end{matrix} ]$$

In the DC prediction mode, the DC prediction value is dc, and we have
p_{dc}(r,c)=dc, for all r and c. (4)

The HT of p_{dc}, P_{dc}, is all zero except for the DC coefficient given by
P_{dc}(0,0)=16×dc. (5)

Therefore, only one operation is needed for the computation of the HT for DC prediction.

In the horizontal prediction mode, the prediction signal is denoted by

$${p}_{h} = [ \begin{matrix}h1 & h1 & h1 & h1 \\ h2 & h2 & h2 & h2 \\ h3 & h3 & h3 & h3 \\ h4 & h4 & h4 & h4\end{matrix} ] . \qquad ( 6 )$$

Let h=[h1 h2 h3 h4]^{T} be the 1-D horizontal prediction vector. Then, the HT of pₕ is

$$\begin{matrix}{P}_{h} = H \times [ \begin{matrix}h1 & h1 & h1 & h1 \\ h2 & h2 & h2 & h2 \\ h3 & h3 & h3 & h3 \\ h4 & h4 & h4 & h4\end{matrix} ] \times {H}^{T} \\ = [ \begin{matrix}H \times h & H \times h & H \times h & H \times h\end{matrix} ] \times {H}^{T} \\ = [ \begin{matrix}4 \times H \times h & 0 & 0 & 0\end{matrix} ]\end{matrix} \qquad ( 7 )$$

Equation (7) suggests that the matrix Pₕ can be determined by a single 1-D transform of the horizontal prediction vector, H×h, plus four shift operations. This is much simpler than the eight 1-D transforms needed in the prior art method.

In the vertical prediction mode, the predicted signal is denoted by

$${p}_{v} = [ \begin{matrix}v1 & v2 & v3 & v4 \\ v1 & v2 & v3 & v4 \\ v1 & v2 & v3 & v4 \\ v1 & v2 & v3 & v4\end{matrix} ] . \qquad ( 8 )$$

Let v=[v1 v2 v3 v4] be the 1-D vertical prediction vector. Then, the HT of pᵥ is

$$\begin{matrix}{P}_{v} = H \times [ \begin{matrix}v1 & v2 & v3 & v4 \\ v1 & v2 & v3 & v4 \\ v1 & v2 & v3 & v4 \\ v1 & v2 & v3 & v4\end{matrix} ] \times {H}^{T} \\ = H \times {[ \begin{matrix}v \times {H}^{T} & v \times {H}^{T} & v \times {H}^{T} & v \times {H}^{T}\end{matrix} ]}^{T} \\ = {[ \begin{matrix}4 \times v \times {H}^{T} & 0 & 0 & 0\end{matrix} ]}^{T}\end{matrix} \qquad ( 9 )$$

Equation (9) suggests that Pᵥ can be determined by a single 1-D transform of the vertical prediction vector, v×H^{T}, plus four shifting operations. This is much simpler than the eight 1-D transforms needed by the prior art method.

For the above three prediction modes, the three predicted signals, P_{dc}, Pₕ, and Pᵥ, have mostly zero components. P_{dc} has just one non-zero component, Pₕ has non-zero values only in its first column, and Pᵥ has non-zero values only in its first row. Therefore, the complexity of determining 314 the difference between the input and the predicted HT-coefficients is also reduced.

Similar reductions in computation for the transformed prediction are also possible for other modes, i.e., modes that predict along diagonal directions.

Determining Distortion in Transform-Domain

In the following, we provide a method for determining 318 the distortion in the transform-domain such that the distortion is approximately equivalent to the commonly used sum-of-squared-differences (SSD) distortion measure in the pixel-domain.

The SSD distortion in the pixel-domain is determined between the input signal and the reconstructed signal. The input signal, reconstructed signal, predicted signal, prediction error, and reconstructed prediction error are x, \hat{x}, p, e, ê, respectively. They are all 4×4 matrices. The SSD distortion D is
D=trace((x−\hat{x})×(x−\hat{x})^{T}).

Because x=p+e, and x=p+ê,
D=trace((e−ê)×(e−ê)^{T}). (10)

If the HT of e is E, i.e., E=H×e×H^{T}, then it follows that
e=H^{T}×E×(H^{T})⁻¹. (11)

The variable Ê is the signal whose inverse HT is ê, and taking into consideration the scaling after inverse HT in the H.264/AVC specification, we have
ê= 1/64(\tilde{H}ᵢₙᵥ×Ê×\tilde{H}ᵢₙᵥ^{T}), (12)
where \tilde{H}ᵢₙᵥ is the kernel matrix of the inverse HT used in the H.264/AVC standard

$${\tilde{H}}_{inv} = [ \begin{matrix}1 & 1 & 1 & \frac{1}{2} \\ 1 & \frac{1}{2} & - 1 & - 1 \\ 1 & - \frac{1}{2} & - 1 & 1 \\ 1 & - 1 & 1 & - \frac{1}{2}\end{matrix} ] .$$

The goal is to determine the distortion from E and Ê, which are the input into the distortion computation block 318.

From equations (11) and (12), we have

$$\begin{matrix}e - \hat{e} = {H}^{- 1} \times E \times {( {H}^{T} )}^{- 1} - \frac{1}{64} ( {\tilde{H}}_{inv} \times \hat{E} \times {\tilde{H}}_{inv}^{T} ) \\ = \frac{1}{64} ( {H}^{- 1} \times 64 \times E \times {( {H}^{T} )}^{- 1} - {\tilde{H}}_{inv} \times \hat{E} \times {\tilde{H}}_{inv}^{T} ) .\end{matrix}$$

Let M₁=diag(4,5,4,5), and \tilde{H}ᵢₙᵥ=⁻¹×M₁ and \tilde{H}ᵢₙᵥ^{T}=M₁×(H^{T})⁻¹. Therefore,

$$e - \hat{e} = \frac{1}{64} ( {H}^{- 1} \times 64 \times E \times {( {H}^{T} )}^{- 1} - \\ {H}^{- 1} \times {M}_{1} \times \hat{E} \times {M}_{1} \times {( {H}^{T} )}^{- 1} ) \\ = \frac{1}{64} ( {H}^{- 1} \times ( 64 \times E - {M}_{1} \times \hat{E} \times {M}_{1} ) \times {( {H}^{T} )}^{- 1} ) . \qquad ( 13 )$$

Let
Y=64×E−M₁×Ê×M₁, (14)
and then substitute equations (13) and (14) into equation (10). We obtain

$$D = trace ( ( e - \hat{e ) \times } ( e - \hat{{e )}^{T} )} \\ = trace ( \frac{1}{{64}^{2}} ( {H}^{- 1} \times Y \times {( {H}^{T} )}^{- 1} \times {H}^{- 1} \times {Y}^{T} \times {( {H}^{T} )}^{- 1} ) ) . \qquad ( 15 )$$

Let M₂=(H^{T})⁻¹×H⁻¹=diag(0.25,1,0.25,1). We also have (H^{T})⁻¹=M₂×H, so (15) becomes

$$D = trace ( \frac{1}{{64}^{2}} ( {H}^{- 1} \times Y \times {M}_{2} \times {Y}^{T} \times {M}_{2} \times H ) ) \\ = \frac{1}{64} trace ( Y \times {M}_{2} \times {Y}^{T} \times {M}_{2} ) . \qquad ( 16 )$$

Expanding equation (16), we obtain

$$D = \frac{1}{64} ( \begin{matrix}\frac{1}{16} \times ( {Y ( 1 , 1 )}^{2} + {Y ( 1 , 3 )}^{2} + {Y ( 3 , 1 )}^{2} + {Y ( 3 , 3 )}^{2} ) + \\ ( {Y ( 2 , 2 )}^{2} + {Y ( 2 , 4 )}^{2} + {Y ( 4 , 2 )}^{2} + {Y ( 4 , 4 )}^{2} ) + \\ \frac{1}{4} \times ( \begin{matrix}{Y ( 1 , 2 )}^{2} + {Y ( 1 , 4 )}^{2} + {Y ( 2 , 1 )}^{2} + {Y ( 4 , 1 )}^{2} + \\ {Y ( 2 , 3 )}^{2} + {Y ( 3 , 2 )}^{2} + {Y ( 3 , 4 )}^{2} + {Y ( 4 , 3 )}^{2}\end{matrix} )\end{matrix} ) . \qquad ( 17 )$$

Therefore, the distortion then can be determined from equation (17), where Y is give by equation (14).

Note that the inverse HT specified in the H.264/AVC specification is not strictly linear because an integer shift operation is used to realize the division-by-two. Therefore, there are small rounding errors between the above-described transform-domain distortion and the distortion computed in the pixel-domain. In addition, the approximation error is made even smaller by the downscaling-by-64 following the inverse HT.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A method for selecting an optimal coding mode for each macroblock in a video, there being a plurality of candidate coding modes, each macroblock including a set of macroblock partitions, comprising:
determining a difference between input transform coefficients of an input macroblock partition and predicted transform coefficients of a predicted macroblock partition;
quantizing the difference to yield a quantized difference;
performing an inverse quantization on the quantized difference to yield a reconstructed difference;
determining a rate required to code the quantized difference, and a distortion according to the difference and the reconstructed difference;
determining a cost for each of the plurality of candidate modes based on the rate and the distortion; and
selecting the candidate coding mode that yields a minimum cost as the optimal coding mode for the input macroblock partition.

2. The method of claim 1 further comprising:
selecting the optimal coding mode for each macroblock yielding the minimum cost for the set of macroblock partitions.

3. The method of claim 1, in which the input transform coefficients of the input macroblock partition and the predicted transform coefficients of the predicted macroblock partition are transformed in a pixel-domain.

4. The method of claim 1, in which the input transform coefficients of the input macroblock partition are transformed directly in a transform-domain.

5. The method of claim 1, in which candidate coding modes include intra-modes and inter-modes.

6. The method of claim 1, in which the predicted transform coefficients are determined for a plurality of intra-prediction modes, including a DC prediction mode, a horizontal prediction mode, and a vertical prediction mode.

7. The method of claim 6, in which the predicted transform coefficients for the DC prediction mode are determined according to a DC prediction value.

8. The method of claim 6, in which the predicted transform coefficients for the horizontal prediction mode are determined according to a single transformation of a 1-D horizontal prediction vector.

9. The method of claim 6, in which the predicted transform coefficients for the vertical prediction mode are determined according to a single transformation of a 1-D vertical prediction vector.

10. The method of claim 1, in which the distortion is determined in a transform-domain.

11. The method of claim 1, in which the distortion is approximated by a sum-of-squared-differences distortion measure in a pixel-domain.

12. The method of claim 1, in which the optimal coding mode is used to transcode the input macroblock partition.

13. The method of claim 12, in which the transcoding is to a different format based on a single transformation kernel.

14. The method of claim 12, in which the transcoding is to a different format based on a different transformation kernel.

15. A system for selecting an optimal coding mode for each macroblock in a video, there being a plurality of candidate coding modes, each macroblock including a set of macroblock partitions, comprising:
an adder configured to determine a difference between input transform coefficients of an input macroblock partition and predicted transform coefficients of a predicted macroblock partition;
a quantizer applied to the difference to yield a quantized difference;
an inverse quantization applied to the quantized difference to yield a reconstructed difference;
means for determining a rate required to code the quantized difference, and a distortion according to the difference and the reconstructed difference;
means for determining a cost for each of the plurality of candidate modes based on the rate and the distortion; and
means for selecting the candidate coding mode that yields a minimum cost as the optimal coding mode for the input macroblock partition.
